(19) United States
(12) Patent Application Publication
(10) Pub. No.: US 2005/0263448 A1
(43) Pub. Date: Dec. 1, 2005

(54) Systems for the removal of solids from fluids and methods of using the same

(75) Inventors: James A. Heist, Cary, NC (US); Alex Davey, Belcamp, MD (US); John Fitzgerald, Main Ridge (AU)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: CDS Technologies, Inc., Morgan Hill, CA (US)

(21) Appl. No.: 11/134,085

(22) Filed: May 19, 2005

Related U.S. Application Data
(63) Continuation-in-part of application No. 10/848,974, filed on May 18, 2004.
(60) Provisional application No. 60/471,677, filed on May 18, 2003.

(51) Int. Cl. B01D 29/35; B01D 35/22; B01D 36/04

(52) U.S. Cl. 210/304; 210/306; 210/804

(57) ABSTRACT

A system for treating a fluid comprising solids and particulates where the system includes a separation device that includes a chamber having an outlet and an inlet, and a separation panel within the chamber that is located above and in fluid communication with the inlet, where the separation panel includes a plurality of openings sized smaller than the solids and larger than the particulates. The separation panel also includes a plurality of deflectors to deflect the solids away from the separation panel while the fluid passes through the openings in the separation panel to remove the solids from the fluid. The inlet is preferably located tangentially to the separation panel. The system also includes a maturing area, in fluid communication with the separation device, to receive the fluid, where one or more additives are added to the fluid in the maturing area to create formed and enlarged particles from the particulates in the fluid, and where the formed and enlarged particles are removed from the fluid by the separation device.

### CROSS-REFERENCES TO RELATED APPLICATIONS

This application is a continuation-in-part of U.S. application Ser. No. 10/848,974, filed May 18, 2004, entitled “SYSTEMS FOR THE REMOVAL OF SOLIDS FROM FLUIDS AND METHODS OF USING THE SAME”, which claims the benefit of U.S. Provisional Application No. 60/471,677 filed May 18, 2003, entitled “POTABLE WATER PRE-TREATMENT APPARATUS AND METHODS FOR USING THE SAME” the entire contents of which are herein incorporated by reference. The application is also related to U.S. Pat. No. 5,788,848, issued Aug. 4, 1998, and U.S. Pat. No. 6,511,595, issued Jan. 28, 2003, both of which are entitled “APPARATUS AND METHODS FOR SEPARATING SOLIDS FROM FLOWING LIQUIDS OR GASES” and both of which are hereby incorporated by reference for all purposes, and the specific purposes described therein and herein.

### BACKGROUND OF THE INVENTION

The invention includes systems and methods to treat fluids containing solid contaminants including the separation of solids from the liquids and/or gases in the fluid. The invention also includes systems and methods for forming enlarged particles from smaller particulates in the fluid to separate the particles from the rest of the fluid. Fluids treated with the invention include, for example, raw water (e.g., waste water, storm water, etc.).

Particulate contamination of fluids (i.e., liquids and gases) presents environmental and public health challenges on several fronts: Particulates, such as dust and soot contained in gaseous effluents, are generated in a wide variety of industries such as power generation, and waste incineration, among others. These particulates are believed to contribute to respiratory health problems such as asthma. Thus, there continues to be need for technologies that remove solid particulates from gaseous effluents that are released into the air.

Solid waste pollutants carried by water also present problems for the environment and public health. For example, stormwater being directed to waterways and seas is a major carrier of solid pollutants such as plastics, cans, tree branches, and animal feces, among other pollutants.

There have been many endeavors to capture solid pollutants being carried by gases and liquids to limit their damage and make the fluids available for use (e.g., potable water). In the case of stormwater, one method for capturing solid pollutants has been to place grates across drain outlets. Unfortunately, the grates must have openings that are sufficient to allow the water to pass through them even when solid pollutants are trapped against the grate. Typically, the openings have to be so large that substantial numbers of solid pollutants escape with the water. Even when the grates have relatively large openings, it is often still necessary to provide flow paths around the grate and/or over the grate to prevent buildup of water upstream of the drain. Such systems are inadequate to capture small particulates that are several times smaller than the size of the grate openings. Thus, there remains a need for technologies that can remove solids having a wide range of sizes from stormwater while maintaining a high throughput of treated water.

Solid waste pollutants carried by water also include human and animal waste transported by sewage systems. These systems often draw from the same water resources as municipal drinking water systems, whose capacities are increasingly stressed by human population growth. One way to reduce the competition for water resources between sewage and drinking water systems, is to convert waste water from the sewage systems into potable water for the drinking systems. Thus, there remains a need to develop systems and methods for waste water treatment that include the removal of solid wastes having a wide range of sizes in a high throughput, cost effective manner. These and other challenges facing the removal of solid pollutants from fluid streams are addressed by the present invention.

### BRIEF SUMMARY OF THE INVENTION

Embodiments of the invention include a system for treating a fluid that includes solids and particulates. The system includes a separation device that includes a chamber having an outlet and an inlet, and a separation panel within the chamber that is located above and is in fluid communication with the inlet. The separation panel includes a plurality of openings sized smaller than the solids and larger than the particulates. The separation panel also includes a plurality of deflectors to deflect the solids away from the separation panel while the fluid passes through the openings in the separation panel to remove the solids from the fluid. The inlet is preferably located tangentially to the separation panel. The system also includes a maturing area, in fluid communication with the separation device, to receive the fluid, where one or more additives are added to the fluid in the maturing area to create formed and enlarged particles from the particulates in the fluid. The formed and enlarged particles are removed from the fluid by the separation device.

Embodiments of the invention also include a system for producing pre-treated water from raw water containing solids for producing potable or municipal water. The system includes a separation device for separating particulates from said raw water. The separation device includes a chamber having an outlet and an inlet, and a separation panel within the chamber located above the inlet and in fluid communication with the inlet. The separation panel defines a separation chamber within the chamber, where the separation panel includes a plurality of openings, the openings being sized smaller than said particulates. The separation panel also includes a plurality of deflectors, where the deflectors deflect the particulates away from the separation panel while permitting said fluid to pass through the openings to separate the particulates from the fluid. The inlet is preferably located tangentially to the separation panel. The separation device also includes a washer for washing said particulates from the separation panel, where the washer is in fluid communication with a washing fluid source to supply the washer with washing fluid. The washer has one or more nozzles for directing the washing fluid towards the separation panel to wash the particles from the separation panel. When the washer directs the washing fluid towards the separation panel, one or more of the particles is washed from the separation panel. The system also includes a maturing area for receiving the raw water input and adding and mixing with the raw water one or more additives to induce, over a period of time, particle formation or enlargement of the solids in the raw water to produce matured raw water. The maturing area retains the raw water for a selected period of time to produce matured raw water, where the maturing area is in fluid communication with the separation device. When raw water enters the maturing area, the one or more additives is added to produce the formed or enlarged particles, and the separation device removes the formed or enlarged particles from the matured raw water to produce pre-treated water.

Embodiments of the invention also include a method for pre-treating raw water containing solids for producing potable or municipal water. The method includes the step of providing a maturing area for receiving the raw water input and adding and mixing with the raw water one or more additives to induce, over a period of time, particle formation or enlargement of said solids in the raw water to produce matured raw water. The maturing area retains the raw water for a selected period of time to produce matured raw water. The maturing area is in fluid communication with the separation device, and when raw water enters the maturing area, the one or more additives is added to the raw water to induce the formation or enlargement of solids. The method also includes the step of providing a separation device for separating the formed or enlarged solids from the matured water. The separation device includes a chamber having an outlet and an inlet, the chamber being in fluid communication with the maturing area. The separation device also includes a separation panel within the chamber located above and in fluid communication with the inlet, the separation panel defining a separation chamber within the chamber. The separation panel includes a plurality of openings, where the openings are sized smaller than the formed or enlarged solids. The separation panel also includes a plurality of deflectors, where the deflectors deflect the formed or enlarged solids away from the separation panel while permitting the fluid through the openings to separate the formed or enlarged solids from the fluid. The inlet is preferably located tangentially to the separation panel. The method also includes the step of introducing the raw water into the maturation area, where the raw water matures to become matured water in which formed or enlarged solids are suspended. The method also includes passing the matured water to the separation device, where the separation device separates some or substantially all of the formed or enlarged solids from the matured water to produce pre-treated water for producing municipal or potable water.

Additional features are set forth in part in the description that follows, and in part will become apparent to those skilled in the art upon examination of the following specification or may be learned by the practice of the invention. The features and advantages of the invention may be realized and attained by means of the instrumentalities, combinations, and methods particularly pointed out in the appended claims.

### BRIEF DESCRIPTION OF THE DRAWINGS

FIG. 1A shows a continuous deflection separation unit according to embodiments of the invention.

FIG. 1B shows a close-up view of a segment of a separation panel used to entrain particles in a fluid flow path according to embodiments of the invention.

FIGS. 2A-G show a screen washing system according to embodiments of the invention.

FIG. 3 shows a treatment state of a continuous flow system with additive/maturing tanks in-line with the continuous deflection separation unit according to embodiments of the invention.

FIG. 4 shows a screen-washing mode of the continuous flow system according to embodiments of the invention.

FIG. 5A illustrates an exemplary inlet cylinder according to embodiments of the invention.

FIGS. 5B-5C illustrate inlet placement of exemplary separation devices according to embodiments of the invention.

### DETAILED DESCRIPTION OF THE INVENTION

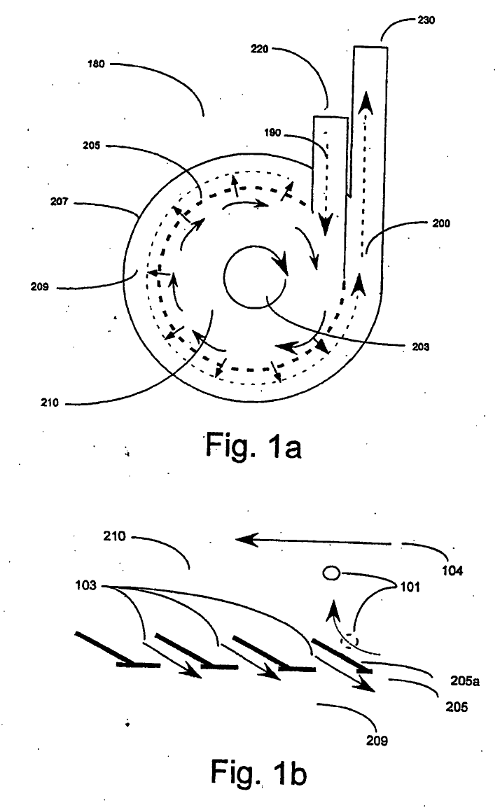

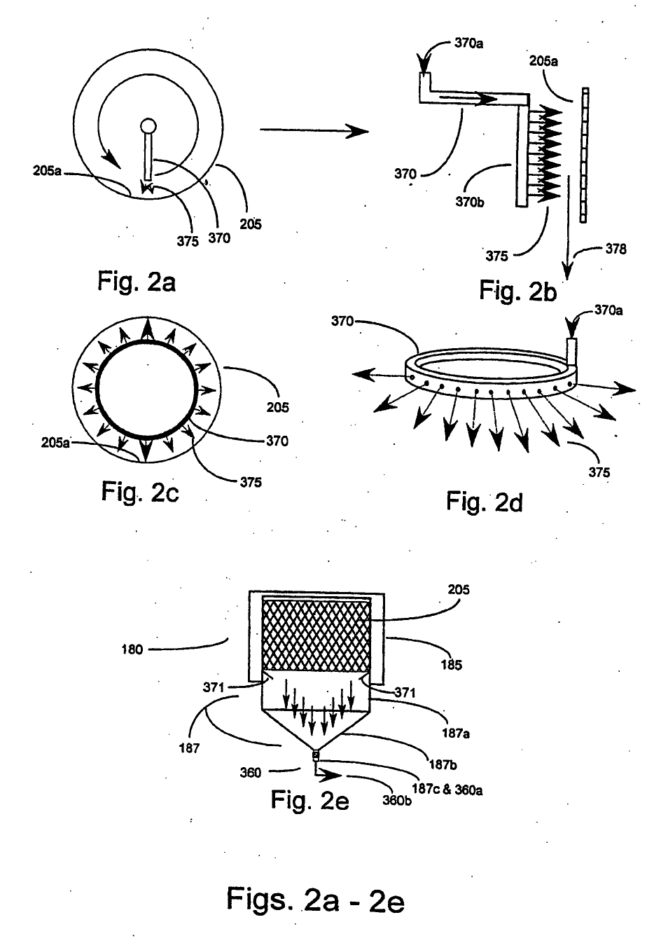

FIG. 1A shows a plan view of an embodiment of a continuous deflection separation device, which is useful in separating solids from a flowing fluid such as water. The continuous deflection separation device 180, includes a separation panel 205, which is preferably circular in shape in cross-section and having first and second open-ends. Separation device 180 is located within chamber 209 defined by outer chamber wall 207.

Exemplary separation panels may be formed from materials generally known as expanded metal or non-metal meshes, or formed by molding or punching similarly shaped panels having the features described herein. Fluid enters continuous deflection separation device 180 via an inlet 220, in the direction of arrow 190, wherein the inlet curves into chamber 210. Water and entrained particles are presented through inlet 220 into separation chamber 210, which is defined by separation panel 205, wherein the generally cylindrical configuration of separation panel 205 imparts a circular flow to the fluid within the confines of separation chamber 209, in the direction shown by arrow 203. As the fluid flows across the surface of separation panel 205, particles 101 are deflected in towards the center of separation chamber 210, whereas the fluid carrying the particles 101 can flow in direction 103 through separation panel 205 into chamber 209 and out outlet 230 along the path indicated by arrow 200.

The resulting arrangement causes an accumulation of particles within the separation chamber as fluid flows through device 180, thus retaining some or all of the particles introduced into device 180 through inlet 220. At some point, it may be desired to remove accumulated particles by aspiration or draining of contents of separation chamber 210, as will be discussed further below. Fluid pressure at inlet 220 may be created by gravity flow, or by pumping fluid into device 180, or by withdrawing fluid from outlet 230.

FIG. 1B depicts an exemplary separation panel 205, which comprises a plurality of deflectors 205a that are generally presented with their closed face to the direction of flow of the liquid as shown by arrow 104 along separation panel 205 within separation chamber 210. Behind each deflector 205a is opening 103 disposed at an angle to the direction of flow (arrow 104). Preferably, openings 103 are all of a predetermined size that generally restricts the passage of particles to be separated from the fluid, whereas the fluid is able to pass through openings 103. Thus, only the fluid, and particles of a size substantially smaller than that of openings 103 are generally able to pass through separation panel 205.

In general, particles larger in size than opening 103 are trapped within the confines of the separation chamber for removal from separation chamber 210, as described below. Circular motion (as depicted by arrow 203) of the fluid within separation chamber 210 facilitates the trapping of particles by continuously deflecting the particles into the center of separation chamber 210, away from separation panel 205, thus making separation panel 205 substantially self-cleaning when in use. Particles trapped within separation chamber 210 may continue moving by the circular flow, as depicted by arrow 203, until they settle under gravity. Floatable particles may be retained on the surface, or accumulate in a suspension to the extent that the fluidic nature of the fluid changes. For example, the effective viscosity of the fluid may prevent its passage through openings 103 at a rate to cause sufficient overall flow through device 180 at a rate to sustain circular motion of the fluid as depicted by arrow 203. Meanwhile, particles and fluid able to pass through openings 103 may exit device 180 through outlet 230.

FIG. 1A depicts an embodiment where the flow of the fluid outside separation chamber 210 is in a direction opposite of that within separation chamber 210. Not wishing to be bound by theory, this counter-current flow motion on opposite sides of separation panel 205 is believed to establish a kinetic equilibrium which in turn facilitates the self-cleaning nature of the circular flow motion established within the separation chamber as depicted by arrow 203. In other embodiments, the flow outside of separation chamber 210 may be in the same direction as the flow within separation chamber 210.

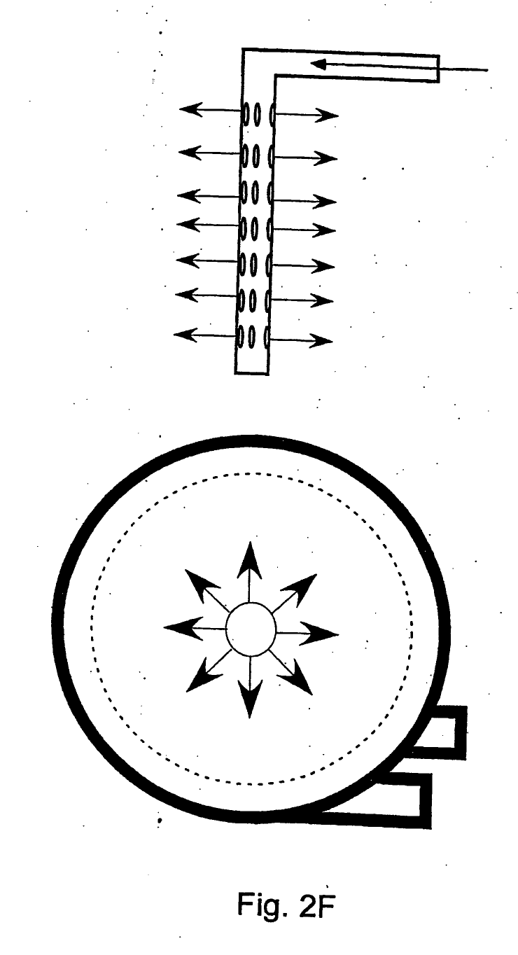

FIG. 2E depicts an embodiment where device 180 may also include sump 187 for the containment (and removal, if desired) of settleable particles. Sump 187 may be designed so as cause a slowing down of the circular flow of the liquid at the lower sump portion 187b, so as to facilitate settlement of particles. Sump 187 may also include an outlet 360a and outlet valve 187a to permit occasional removal of settled particles by gravity or pumped flow, and could further include, for example, further concentration of the settled particles into a screening bucket (not shown). Floating particles, or particles that do not settle, may be removed by skimming, or draining. Draining the particles may be accompanied by a washing step caused by a separation panel washer, such as shown in FIGS. 2A-D.

FIGS. 2A-D show different views of two different types of elements that can be used to assist in the cleaning of separation panel 205 and facilitate the movement of particles out of separation chamber 210 via sump outlet 360. FIG. 2A shows a plan-view of an arm type washer element 370, where washing fluid is passed through washer element 370 to emanate from one or more nozzles located along arm portion 370b, which direct washing fluid against inner side 205a of separation panel 205 to cause particles to wash off inner side 205a in a downward direction as depicted by arrow 378 as shown in FIG. 2B. FIG. 2A shows washing element 370 rotating about the center axis of separation chamber 210 to move the nozzles across inner side 205a of separation panel 205 as shown in FIG. 2D.

In another embodiment, FIG. 2C shows washer element 370 comprising a ring or arc structure that provides for one or more nozzles for directing washing fluid against inner side 205a of separation panel 205 for washing particles. The ring, as shown in FIG. 2D, or arc structure of washing element 370 is moved up and down the center axis of the cylinder 5 formed by separation panel 205 to move the nozzles along inner side 205a of separation panel 205 to cause the particles to move towards sump outlet 360.

FIG. 2E shows an embodiment where sump 187 further comprises flange 371 for assisting the settlement of particles into sump 187. Flange 371 may be a downwardly directed annular flange or baffle that assists in directing downwardly moving solids into sump 187. Flange 371 may also substantially prevent the circular motion of the fluid within the upper regions of the separation chamber from being transferred into the sump 187.

FIG. 2F shows an embodiment where a shower head 275 is used to direct liquid against the separator panel to wash material away. FIG. 2G shows another embodiment of a shower head 277 used to direct a liquid against the separator to wash material away.

The inlet of the separation device may be in fluid communication with the separation device, and thus the separation panel, in any suitable manner known in the art. For instance, the inlet may be located above, below, or concurrently with the separation panel so as to direct the influent flow above, below, or substantially concurrent with the panel level. In one embodiment, the inlet is configured so as to bring influent flow into the separation device tangentially to, and below the level of the separation panel. Further, the inlet may be configured so as to be below the invert elevation of the up-stream pipe of the separation device.

Without intending to be limited by theory, providing influent flow below the level of the separation panel substantially eliminates the condition of direct screening during the initial operation of a separation device, e.g., during start-up, after cleaning, or after draining. In flocking applications, this may be desirable because a substantial amount of floc may be extruded through the screen during the period of direct screening, thus requiring a period of recycled flow to the maturation tank or the inlet.

In addition, there may be improved solids capture due, at least in part, to the centrifugal force of the inlet, which forces heavier-than-water solids to the wall of the inlet section and down onto the floor, where the solids move into the sump and are captured. This initial solids capture reduces the amount of solids that are moving along the separation panel surface. The loss of solids through the separation panel may thereby be further reduced. Moreover, improved deflective functionality is observed where the solids are most concentrated, i.e., near the bottom of the separation panel.

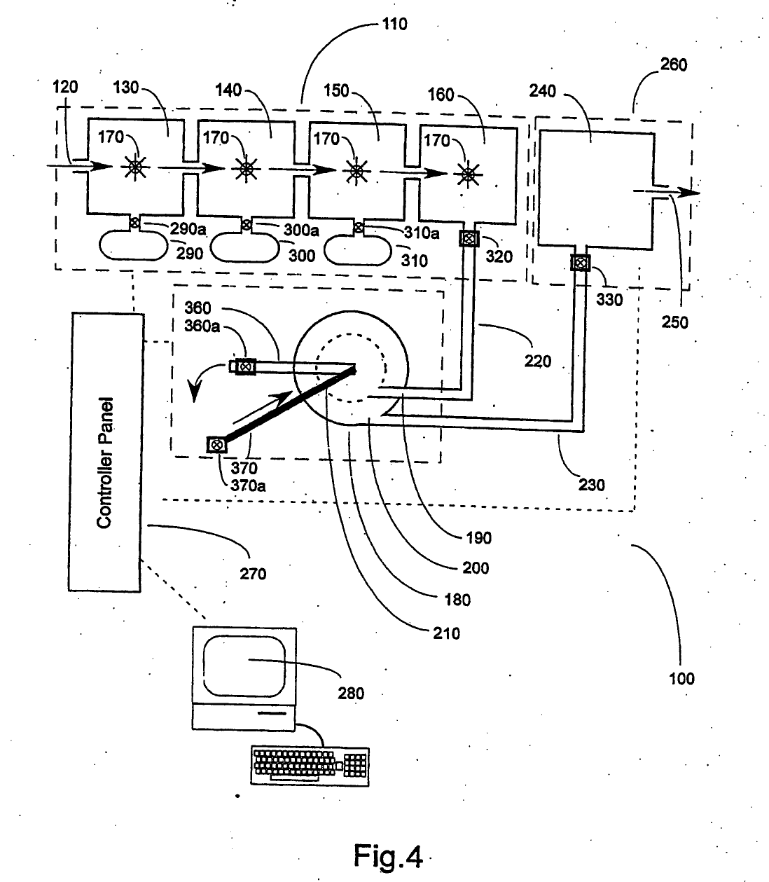

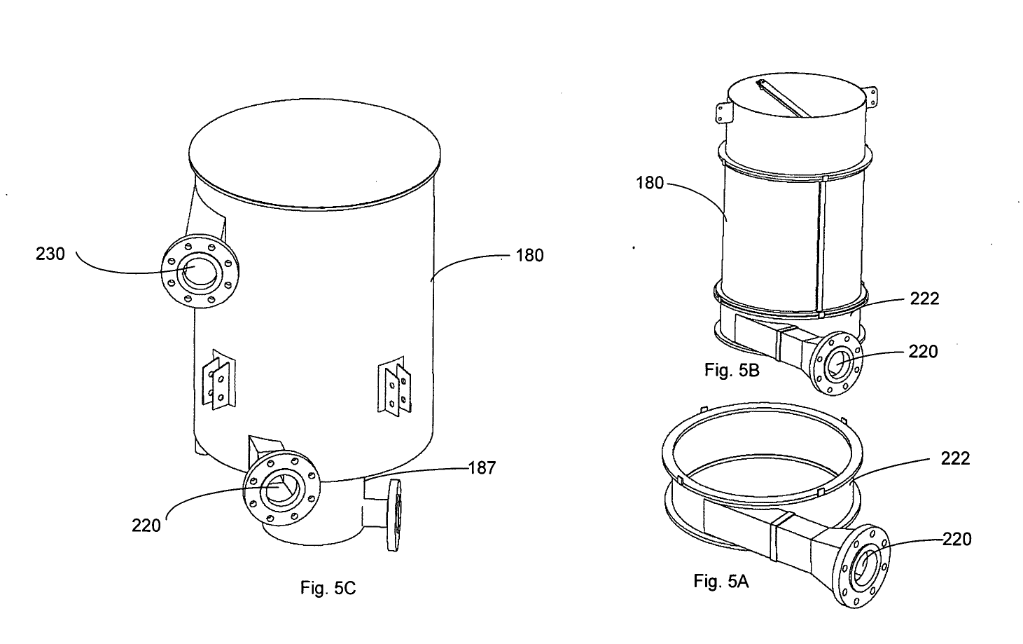

Now, with reference to FIG. 5A, an exemplary inlet cylinder 222 is illustrated which may be used in connection with a separation device of the invention to provide a configuration wherein the inlet 220 is located below the separation panel. The inlet cylinder size and geometry may be designed for suitable facilities similar to conventional inlets (e.g., the inlet area may typically be between about ½% and 2% of the separation panel area, and the width of the inlet may be between about 10% and about 20% of the separation panel diameter). The inlet cylinder may be fabricated into, e.g., a solid ring from any suitable material, such as concrete or steel, and may sit above the ground of the volute area, as known in the art.

As shown in FIG. 5B, inlet cylinder 222 may be placed directly below separation device 180 (which houses the separation panel) such that inlet 220 is located below separation panel 205 (not shown). Inlet cylinder 222 may be configured tangentially to separation panel 205 (not shown), and may be located below separation panel 205 by a suitable distance, e.g., several inches to a foot ore more. The separation device 180 may optionally include sump 187 (not shown), etc.

FIG. 5C illustrates an alternative configuration of separation device 180 wherein inlet 220 is located substantially concurrently with the bottom of separation panel 205 (not shown). FIG. 5C also illustrates outlet 230 and sump 187.

Where more purified fluids are required at the conclusion of the filtration procedure, it is possible for the outlet from a first device according to the invention to feed into the inlet for a second device, and therefore, for the fluid to be filtered sequentially by two or more such devices, arranged in series. In such an arrangement, the size of the openings in the separation panels for the second and subsequent separators could be sequentially (and increasingly) smaller, so that each subsequent separator removes increasingly finer particles. Hence, by this arrangement, very high, or indeed, any desired level of filtration or purification could be achieved. Alternatively, for high-throughput filtration, two or more devices may be banked in parallel to provide higher throughput than a single unit.

While much of the foregoing description of the embodiments has been concerned with apparatus for separating particles entrained in liquids it is to be understood that the invention may also be used for the separation of solids entrained in gases. Operation of gas/solid separators constructed in accordance with embodiments of the invention, may include a sealed unit separator that slows or prevents the undesired escape of gases undergoing filtration. Sealing the unit may also be utilized in liquid/solid separators constructed in accordance with the present invention. In this way, solid matter entrained in exhaust gases and gaseous emissions from various manufacturing plants may be filtered in much the same way as solid-bearing liquids are treated according to embodiments of apparatuses and methods of the present invention.

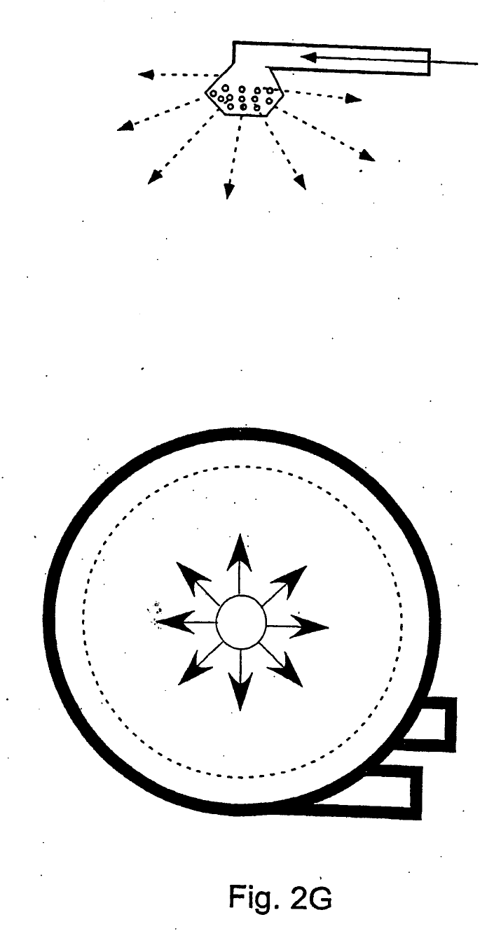

FIG. 3 shows an embodiment of an apparatus that utilizes the separation device 180 described above. In FIG. 3, device 180 is situated downstream from one or more additive sources, such as additive sources 290, 300, 310, and 320, for providing, for example, a flocculent or polymer additive, used to form or enlarge particles in a fluid-particle suspension for later separation by device 180. By flocculating smaller particles into a larger particle the separation efficiency of device 180 may be enhanced. For example, a separator panel made from a 1200 micron screen mesh loses efficiency in removing solids below 100 μm. By flocculating smaller waste particles (e.g., sewage particles having sizes from about 0.4 μm to about 40 μm) into a larger flocculated particles (e.g., an aggregate particle having a size about 100 μm or larger) a greater percentage of the smaller particles can be separated with device 180. The addition of additives from additive sources, such as 290, 300, 310, and 320 may be regulated by valves and/or pumps such as valve/pumps 290a, 300a, 310a, and 320a. Additive sources may further feed into one or more maturing tanks in serial fluid communication, such as maturing tanks 130, 140, 150, and 160, and each tank may also have an impeller 170 for mixing the contents of each tank. Additive sources and maturing tanks may collectively be referred to as maturation area 110.

Each of the additive sources may be under the global control of controller panel 270, which may be under the direction of computer unit 280. Controller panel 270 and/or computer unit 280 may further be in communication with inlet control valve/pump 320 and/or outlet control valve/pump 330 for regulating flow of fluid from maturation area 110 through device 180 and onto optional storage tank 260, which serves to store treated, or pre-treated fluid (if downstream processing is to occur).

One of ordinary skill in the art would realize that other configurations of pumps and valves may be utilized to regulate the flow of fluids through device 180. Treated fluid from storage tank 240 may optionally be tapped to supply washing element 370 during a separation panel washing cycle. Valves 370a and 360a may also be controlled by controller panel to empty sump 187 and wash separation panel 205 during a separation panel wash cycle.

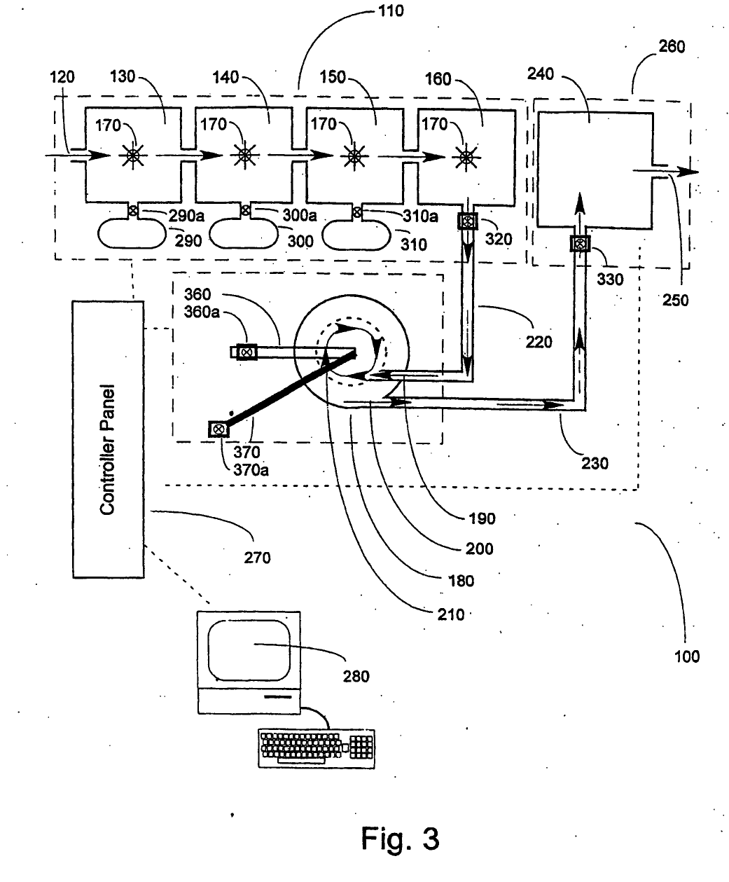

FIG. 4 shows the apparatus illustrated in FIG. 3 operating in a separation panel washing mode, where valves 320 and 330 close to stop flow of fluid through the separation device 180, and where valve 360 opens to drain fluid from separation device 180 through drain pipe 360. In addition, valve or pump 370a opens to flow washing fluid through washing arm 370 to apply washing fluid against separation panel 210 to cause accumulated material to be washed down and drained through drain pipe 360.

After a selected period of time washing, valve or pump 370a closes or stops the flow of washing fluid flowing through washing arm 370, and drain valve 360 closes. With separation device 180 in a clean state, the apparatus is now ready to continue operation by opening valves 320 and 330 to once again establish flow through separation device 180. During the separation panel washing mode, fluid coming into the apparatus accumulated within the maturing area 110. Furthermore, fluid to wash separation panel 210 may be derived from holding tank 240 through a fluid connection (not shown) with valve or pump 370a.

### EXAMPLES

Potable water pre-treatment systems according to embodiments of the invention were used to treat raw water in three different locations. The systems could treat about 3 to about 5 liters/second (i.e., about 70,000 to about 115,000 gallons per day) of raw surface water as pretreatment for drinking water use. Tables 1-3 show operating conditions for each location were the systems were tested:

TABLE 1
Operating Conditions for Pretreatment of River
Water in Western Pennsylvania:

| Location | Western Pennsylvania | | | |
|---|---|---|---|---|
| Water Source | River | | | |
| Season of Year | Fall | | | |
| Coagulant Type | Poly-Aluminum Chloride | | Poly-Aluminum Chloride | |
| Coagulant dose | 30 mg/l | | 30 mg/l | |
| (mg/l) | | | | |
| Flocculant Type | Anionic, high Molecular | | Cationic, high Molecular | |
| | Weight, medium CD | | Weight, medium CD | |
| Flocculant Dose | 1 mg/l | | 1 mg/l | |
| (mg/l) | | | | |
| Turbidity In/Out | 25-230 NTU | 0.8-2.5 NTU | 25-60 NTU | 1-2 NTU |

TABLE 2
Operating Conditions for Pre-treatment of Reservoir
Water in Western Pennsylvania

| Location | Western Pennsylvania | |
|---|---|---|
| Water Source | Reservoir | |
| Season of Year | Summer | |
| Coagulant Type | Poly-Aluminum Chloride | |
| Coagulant dose (mg/l) | 30 mg/l | |
| Flocculant Type | Anionic, high Molecular Weight, medium CD | |
| Flocculant Dose (mg/l) | 1 mg/l | |
| Turbidity In/Out | 1-1.5 NTU | 0.4-0.6 NTU |

TABLE 3
Operating Conditions for Pretreatment of River Water in West Virginia:

| Location | West Virginia | | | |
|---|---|---|---|---|
| Water Source | River | | | |
| Season of Year | Spring | | | |
| Coagulant Type | Ferric Chloride | | Poly-Aluminum Chloride | |
| Coagulant dose | 30 mg/l | | 40 mg/l | |
| (mg/l) | | | | |
| Flocculant Type | Cationic, high Molecular | | Anionic, high Molecular | |
| | Weight, medium CD | | Weight, medium CD | |
| Flocculant Dose | 1 mg/l | | 1 mg/l | |
| (mg/l) | | | | |
| Turbidity In/Out | 72-86 NTU | 1.8 NTU | 50-62 NTU | 2-5 NTU |

Performance of this demonstration unit has been as good or better as the performance of full-scale conventional-technology water pre-treatment facilities. The continuous deflective separation systems described herein may also be designed with scale-up methods for facilities of varying capacity. These scale-up methods can be used to design drinking water pre-treatment facilities of larger capacities as well.

Those skilled in the art will readily appreciate that the apparatus and methods of the present invention are capable of being put to many different uses, and that they embrace many modifications and variations. It should be understood that the spirit and scope of the present invention is in no way limited to the particular details of the embodiments described herein, but also extends to, and is determined by, reference to the features described by the appended claims.

Also, the words “comprise,” “comprising,” “include,” “including,” and “includes” when used in this specification and in the following claims are intended to specify the presence of stated features, integers, components, or steps, but they do not preclude the presence or addition of one or more other features, integers, components, steps or groups.

1. A system for producing pre-treated water from raw water containing solids for producing potable or municipal water comprising:
(a) a separation device for separating particulates from said raw water comprising;
(i) a chamber having an outlet and an inlet;
(ii) a separation panel within said chamber located above said inlet and in fluid communication with said inlet, said separation panel defining a separation chamber within said chamber, said separation panel comprising a plurality of openings, said openings being sized smaller than said particulates, said separation panel further comprising a plurality of deflectors, said deflectors for deflecting said particulates away from said separation panel while permitting said fluid to pass through said openings to separate said particulates from said fluid;
(iii) a washer for washing said particulates from said separation panel, said washer being in fluid communication with a washing fluid source to supply said washer with washing fluid, said washer having one or more nozzles for directing said washing fluid towards said separation panel to wash said particles from said separation panel, wherein when said washer directs said washing fluid towards said separation panel, one or more of said particles is washed from said separation panel, and
(b) a maturing area for receiving said raw water input and adding and mixing with said raw water one or more additives to induce, over a period of time, particle formation or enlargement of said solids in said raw water to produce matured raw water, said maturing area retaining said raw water for a selected period of time to produce matured raw water, said maturing area being in fluid communication with said separation device, wherein when raw water enters said maturing area, said one or more additives is added to produce said formed or enlarged particles, and wherein said separation device removes said formed or enlarged particles from said matured raw water to produce pre-treated water.

2. The system of claim 1, wherein said inlet is located tangentially to said separation panel.

3. The system of claim 1, wherein said maturing area further comprises a plurality of maturation tanks, said maturation tanks each being in fluidic communication in series,
wherein when said raw water enters said maturation area, said raw water enters into a first of said plurality of maturation tanks, and a portion of said raw water matures in said first maturation tank for a first maturation time period, and then said portion of raw water enters a second maturation tank and a matures in said second maturation tank for a second maturation period of time before entering said separation device.

4. The system of claim 1, further comprising a storage reservoir for storing pre-treated water from said separation device.

5. The system of claim 1, wherein said maturation area further comprises one or more mixers for mixing said additives with said raw or maturing water.

6. The system of claim 1, further comprising one or more valves for controlling fluid flow between said maturation area and said separation device and/or between maturation tanks within said maturation area.

7. The system of claim 1, further comprising a controller for controlling fluid flow through said system.

8. The system of claim 7, wherein said controller is under microprocessor control.

9. The system of claim 1, wherein said washing fluid is supplied from a reservoir of processed fluid previously processed through said separation panel.

10. The system of claim 1, wherein said washer comprises a washing tube axially positioned within said sample chamber substantially parallel with said separation panel, said washing tube having one or more of said nozzles for directing said washing fluid towards said separation panel.

11. The system of claim 1, wherein said washer comprises a ring or arc, said ring or arc having one or more of said nozzles for directing said washing fluid towards said separation panel.

12. The system of claim 1, wherein said washer comprises a washing arm having one or more of said nozzles, said washing arm being rotatably movable about a cylindrical axis of said sample chamber, wherein said nozzles, when moved about said axis, directs said washing fluid towards said separation panel.

13. The system of claim 1, wherein said washer operates while said fluid flow through said device is interrupted.

14. The system of claim 13, further comprising a sump positioned below said sample chamber, wherein said sump collects particulates.

15. The system of claim 14, further comprising a sump outlet for removing said collected particulates from said sump.

16. The system of claim 15, further comprising a sump outlet valve for controlling the removal of said collected particulates from said sump.

17. A method for pre-treating raw water containing solids for producing potable or municipal water comprising the steps of:
(a) providing a maturing area for receiving said raw water input and adding and mixing with said raw water one or more additives to induce, over a period of time, particle formation or enlargement of said solids in said raw water to produce matured raw water, said maturing area retaining said raw water for a selected period of time to produce matured raw water, said maturing area being in fluid communication with said separation device, wherein when raw water enters said maturing area, said one or more additives is added to said raw water to induce said formation or enlargement of solids;
(b) providing a separation device for separating said formed or enlarged solids from said matured water comprising;
(i) a chamber having an outlet and an inlet, said chamber being in fluid communication with said maturing area; and,
(ii.) a separation panel within said chamber located above said inlet and in fluid communication with said inlet, said separation panel defining a separation chamber within said chamber, said separation panel comprising a plurality of openings, said openings being sized smaller than said formed or enlarged solids, said separation panel further comprising a plurality of deflectors said deflectors for deflecting said formed or enlarged solids away from said separation panel while permitting said fluid through said openings thereby separating said formed or enlarged solids from said fluid;
(c) introducing said raw water into said maturation area, said raw water maturing to become matured water having formed or enlarged solids suspended therein;
(d) passing said matured water to said separation device, wherein said separation device separates some or substantially all of said formed or enlarged solids from said matured water to produce pre-treated water for producing municipal or potable water.

18. The method of claim 17, wherein said chamber is provided with said inlet located tangentially to said separation panel.

19. The method of claim 17, further comprising a washer for washing said formed or enlarged solids, if any, from said separation panel, said washer being in fluid communication with a washing fluid source for supplying said washer with washing fluid, said washer having one or more nozzles for directing said washing fluid towards said separation panel for washing said formed or enlarged solids from said separation panel, wherein when said washer directs said washing fluid towards said separation panel, one or more of said formed or enlarged solids is washed from said separation panel.

20. The method of claim 19 wherein said separation device is cleaned by first interrupting flow of matured water between said separation device and said maturation area, then said washer washes said one or more formed or enlarged solids from said separation panel, and followed by resumption of flow of matured water from said maturation area to said separation device.

21. The method of claim 20, wherein said separation device further comprises a water level detector for detecting the water level of matured water entering into said separation device to determine whether said separation panel requires cleaning, and wherein said method further includes the step of monitoring matured water levels within said separation device, and when said matured water levels attain a pre-selected height, said water level indicator causes said interruption of said flow of matured water from said maturation are to said separation device until such time that said separation panel is substantially cleaned of said one or more formed or enlarged solids.

22. The method of claim 20, wherein said separation device comprises a treated water quality monitor that detects the breakthrough of solid particles through the separation panel, indicating the optimal inventory of removed solids has been exceeded, which causes the interruption of said flow of unmatured water from said maturation tank to said separator device and said separation panel has been substantially cleaned of said formed or enlarged solids.

23. A system for treating a fluid comprising solids and particulates, said system comprising:
a separation device comprising a chamber having an outlet and an inlet, and a separation panel within the chamber that is located above and in fluid communication with the inlet, wherein the separation panel comprises a plurality of openings sized smaller than the solids and larger than the particulates, said separation panel also comprising a plurality of deflectors to deflect the solids away from the separation panel while the fluid passes through the openings in the separation panel to remove the solids from the fluid; and
a maturing area, in fluid communication with the separation device, to receive the fluid, where one or more additives are added to the fluid in the maturing area to create formed and enlarged particles from the particulates in the fluid, wherein the formed and enlarged particles are removed from the fluid by the separation device.

24. The system of claim 23, wherein the inlet is located tangentially to the separation panel.

25. The system of claim 23, wherein the system comprises a washer to wash the solids from the separation panel.

26. The system of claim 23, wherein the system comprises a sump positioned below the chamber to collect the solids and the particles.

27. The system of claim 23, wherein the fluid is raw water.

28. The system of claim 23, wherein the enlarged particles have a size of about 100 μm or larger.

29. The system of claim 28, wherein the particulates that form the enlarged particles have an average size of about 0.4 μm to about 40 μm.
